(19) United States
(12) Patent Application Publication
(10) Pub. No.: US 2009/0023002 A1
(43) Pub. Date: Jan. 22, 2009

(54) STRETCHED POLYAMIDE FILM

(76) Inventor: Hiroyuki Nanba, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/573,965

(22) PCT Filed: Aug. 16, 2005
(86) PCT No.: PCT/JP2005/014942

§ 371 Date: Feb. 20, 2007

(30) Foreign Application Priority Data
Aug. 17, 2004 (JP) 2004-237527

(51) Int. Cl. B32B 27/34; B32B 27/08; B32B 27/32; C08L 77/00

(52) U.S. Cl. 428/476.9; 428/474.4; 525/420

(57) ABSTRACT

A stretched film made of a resin mixture of a polyamide resin X with an amorous polyamide resin Y and/or an ionomer resin Z. The polyamide resin X includes a diamine constitutional unit containing 70 mol % or more of m-xylylene diamine unit and a dicarboxylic acid constitutional unit containing 70 mol % or more of C₆-C₁₂ α,ω-aliphatic dicarboxylic acid unit. A film produced by melt-extruding the resin mixture can be stretched in a high ratio exceeding 4 times in at least one direction of MD and TD. The highly stretched film produced by the stretching in a ratio exceeding 4 times exhibits good gas-barrier properties and transparency.

### TECHNICAL FIELD

The present invention relates to gas-barrier stretched films.

### BACKGROUND ART

Multi-layer films having a gas-barrier layer made of a gas-barrier resin such as polyvinylidene chloride (PVDC), ethylene-vinyl alcohol copolymer (EVOH) and polyamides have been used as gas-barrier packaging materials. Among polyamides, a polyamide having m-xylylene skeleton such as poly(m-xylylene adipamide) (hereinafter referred to as “nylon MXD6) which is produced by the polycondensation of m-xylylenediamine and adipic acid is, as compared with other gas-barrier resins, characterized by the little decrease in gas-barrier properties and the quick recovery of gas-barrier properties upon boiling treatment and retort treatment. With such characteristics, nylon MXD6 is recently widely applied to the fields of packaging. For example, a biaxially stretched, laminated film having a layer made of a mixture of an aromatic polyamide such as nylon MXD6 and a polyolefin which is graft-modified with an unsaturated carboxylic acid has been proposed as a packaging film (Patent Document 1).

Patent Document 1: Japanese Patent 3021854

### DISCLOSURE OF INVENTION

Films made of nylon MXD6 have good gas-barrier properties, but have a low impact resistance and flexibility when not stretched. In addition, whitening occurs upon the absorption of moisture and heating. It has been known that the impact resistance and flexibility are improved in some extents by stretching, and also known that the whitening is avoided by stretching. However, the film is broken or the transparency and gas-barrier properties are deteriorated when the stretch ratio exceeds 4 times in at least one direction of MD and TD. Thus, it has been difficult to produce a film having good gas-barrier properties and transparency.

As for polypropylene, films stretched in both directions of MD and TD by 5 to 10 times have been produced. To enhance the gas-barrier properties of polypropylene, the lamination with various gas-barrier resins has been studied. In the lamination with nylon MXD6, however, a laminated polypropylene film having good gas-barrier properties and transparency is difficult to produce, because the nylon MXD6 film is broken or the transparency and gas-barrier properties thereof are deteriorated when stretched under stretching conditions and stretch ratio which are employed for polypropylene.

An object of the present invention is to provide polyamide films having good gas-barrier properties and transparency.

The inventors have studied films made of a mixture of a polyamide having m-xylylene skeleton and other resins on their possible stretch ratio and the properties of stretched films. As a result, it has been found that films made of a mixture of a polyamide having m-xylylene skeleton with an amorous polyamide resin and/or an ionomer resin are not broken even when stretched in a high stretch ratio which cannot be applied to nylon MXD6 films, to provide stretched films having transparency and gas-barrier properties sufficient for practical use. The present invention is based on this finding.

Thus, the present invention relates to a stretched film which is produced by melt-mixing a polyamide resin X with an amorous polyamide resin Y and/or an ionomer resin Z in a weight ratio X/(Y+Z) of 70/30 to 95/5, the polyamide resin X having a diamine constitutional unit containing 70 mol % or more of m-xylylene diamine unit and a dicarboxylic acid constitutional unit containing 70 mol % or more of C₆-C₁₂ α,ω-aliphatic dicarboxylic acid unit; extruding the mixture into a form of film; and stretching the film in a stretch ratio exceeding 4 times in at least one direction of MD and TD.

### BEST MODE FOR CARRYING OUT THE INVENTION

The polyamide resin X used in the present invention is produced by the polycondensation of a diamine component and a dicarboxylic acid component and includes a diamine constitutional unit containing 70 mol % or more, preferably 80 mol % or more and more preferably 90 mol % or more (each inclusive of 100 mol %) of m-xylylene diamine unit and a dicarboxylic acid constitutional unit containing 70 mol % or more, preferably 80 mol % or more and more preferably 90 mol % or more (each inclusive of 100 mol %) of C₆-C₁₂ α,ω-aliphatic dicarboxylic acid unit.

The diamine constitutional unit may contain a diamine unit other than m-xylylene diamine unit in an amount of 30 mol % or less, preferably 20 mol % or less, and more preferably 10 mol % or less (each inclusive of zero). Examples of the diamine unit other than m-xylylene diamine unit include, but not limited to, diamine units derived from aliphatic diamines such as tetramethylenediamine, pentamethylenediamine, 2-methylpentanediamine, hexamethylenediamine, heptamethylenediamine, octamethylenediamine, nonamethylenediamine, decamethylenediamine, dodecamethylenediamine, 2,2,4-trimethylhexamethylenediamine, and 2,4,4-trimethylhexamethylenediamine; alicyclic diamines such as 1,3-bis(aminomethyl)cyclohexane, 1,4-bis(aminomethyl)cyclohexane, 1,3-diaminocyclohexane, 1,4-diaminocyclohexane, bis(4-aminocyclohexyl)methane, 2,2-bis(4-aminocyclohexyl)propane, bis(aminomethyl)decaline, and bis(aminomethyl)tricyclodecane; and aromatic ring-containing diamines such as bis(4-aminophenyl)ether, p-phenylenediamine, p-xylylenediamine, and bis(aminomethyl)naphthalene.

Examples of C₆-C₁₂ α,ω-aliphatic dicarboxylic acid include adipic acid, pimelic acid, suberic acid, azelaic acid, sebacic acid, undecanedioic acid and dodecanedioic acid, with adipic acid being particularly preferred. The dicarboxylic acid constitutional unit may include a unit derived from a dicarboxylic acid other than the α,ω-aliphatic dicarboxylic acid in an amount of 30 mol % or less, preferably 20 mol % or less, and more preferably 10 mol % or less (each inclusive of zero). Examples of the dicarboxylic acid other than the α,ω-aliphatic dicarboxylic acid may include, but not limited to, terephthalic acid, isophthalic acid and 2,6-naphthalenedicarboxylic acid.

The relative viscosity of the polyamide resin X is preferably from 2.3 to 4.2. The relative viscosity is represented by the following formula:

Relative Viscosity=t/t₀

wherein t is a falling time of a solution of one gram of the resin in 100 ml of a 96% sulfuric acid measured at 25° C. using Cannon-Fenske viscometer, and t₀ is a falling time of the 96% sulfuric acid measured in the same manner. When the relative viscosity is within the above range, the occurrence of draw down and the formation of fisheyes due to gelation, etc. can be prevented.

The polyamide resin X may contain a small amount of a unit derived from a monoamine or a monocarboxylic acid which is used as a molecular weight regulator in the production thereof.

The amorous polyamide resin Y used in the present invention includes a constitutional unit preferably derived from an aromatic dicarboxylic acid, more preferably derived from terephthalic acid and/or isophthalic acid. The diamine constitutional unit is not limited as long as the polyamide resin X is amorphous and, for example, may include a unit derived from hexamethylenediamine. Examples of the amorous polyamide resin Y include hexamethylenediamine-isophthalic acid-terephthalic acid copolyamides such as nylon 6I, nylon 6T, nylon 6IT, and nylon 6I6T (wherein I is isophthalic acid and T is terephthalic acid), with nylon 6IT being preferred.

The amorous polyamide resin Y preferably shows no definite melting point in a differential thermal analysis and has a glass transition point of from 50 to 160° C. The melt flow rate (MFR) of the amorous polyamide resin Y is preferably from 1 to 30 g/min when measured at 230° C. under a load of 2160 g (ASTM D1238).

The ionomer resin Z used in the present invention is an olefin-unsaturated carboxylic acid copolymer having a main chain composed of olefin units and unsaturated carboxylic acid units having its pendant carboxyl groups being partially neutralized by metal ions (crosslinked via metal ions). The olefin unit is preferably ethylene unit, and the unsaturated carboxylic acid unit is preferably acrylic acid unit and/or methacrylic acid unit.

Examples of the ionomer resin Z include ethylene-acrylic acid copolymer, ethylene-methacrylic acid copolymer and ethylene-methacrylic acid-acrylic acid copolymer, the pendant carboxyl groups of each copolymer being partially neutralized by metal ions. The content of the acrylic acid unit and/or the methacrylic acid unit in each copolymer is preferably from 10 to 20% by weight and more preferably from 12 to 18% by weight on the basis of the total weight of the ethylene unit, acrylic acid unit and methacrylic acid unit. If being 10% by weight or more, the ionomer resin Z is well dispersed in the polyamide resin X to increase the transparency of the resultant film. If being 20% by weight or less, the film can be stretched in a higher ratio without breaking and the production cost of the ionomer resin is low. The content of the ethylene unit in the copolymer is preferably from 80 to 90% by weight and more preferably from 82 to 88% by weight on the basis of the total weight of the ethylene unit, acrylic acid unit and methacrylic acid unit.

The degree of neutralization of the carboxyl groups in the ionomer resin Z (number of neutralized carboxyl groups/total number of carboxyl groups) is preferably from 20 to 40% and more preferably from 25 to 35%. If being 20% or more, the ionomer resin Z is well dispersed in the polyamide resin X, to increase the transparency of the resultant film. If being 40% or less, the melt flowability of the ionomer resin Z is not lowered, to increase the transparency of the resultant film. Examples of the cation for neutralizing carboxyl groups include, but not limited to, ions of metals such as zinc, sodium, lithium, potassium, magnesium, and calcium, with zinc ion and sodium ion being preferred. MFR (ASTM D1238) of the ionomer resin Z is preferably from 1 to 100 g/min.

The polyamide resin X is mixed with one or both of the amorous polyamide resin Y and the ionomer resin Z.

When both of the amorous polyamide resin Y and the ionomer resin Z are mixed, the weight ratio of the polyamide resin X and the sum of the amorous polyamide resin Y and the ionomer resin Z, X/(Y+Z), is preferably from 70/30 to 95/5 and more preferably from 80/20 to 90/10. The effect of the present invention is obtained when at least one of the amorous polyamide resin Y or the ionomer resin Z is mixed with the polyamide resin X. Therefore, the amorous polyamide resin Y and the ionomer resin Z are combinedly used in any ratio and the weight ratio thereof is not specifically limited.

When only the amorous polyamide resin Y is mixed with the polyamide resin X, the weight ratio of the polyamide resin X and the amorous polyamide resin Y, X/Y, is preferably from 70/30 to 95/5 and more preferably from 80/20 to 90/10. If the amount of the polyamide resin X is within the above range, the film can be stretched in a high stretch ratio without breaking. If the amount of the amorous polyamide resin Y is within the above range, the decrease of gas-barrier properties and the deterioration of transparency can be prevented.

When only the ionomer resin Z is mixed with the polyamide resin X, the weight ratio of the polyamide resin X and the ionomer resin Z, X/Z, is preferably from 70/30 to 95/5 and more preferably from 80/20 to 90/10. If the amount of the polyamide resin X is within the above range, the film can be stretched in a high stretch ratio without breaking. If the amount of the ionomer resin Z is within the above range, the decrease of gas-barrier properties and the deterioration of transparency can be prevented.

The mixture of the polyamide resin X with the amorous polyamide resin Y and/or the ionomer resin Z is prepared by dry-blending the pellets of the resins. Alternatively, the mixture is prepared by melt-kneading the resins in an extruder and then pelletizing.

The mixture of the polyamide resin X with the amorous polyamide resin Y and/or the ionomer resin Z may contain, if needed, an aliphatic polyamide to improve the flexibility and impact resistance. Examples of the aliphatic polyamide include nylon 6, nylon 66, and nylon 6-66. The mixture may further contain, if necessary, an antistatic agent, a lubricant, an antiblocking agent, a stabilizer, a dye and a pigment. The optional resin and additives are mixed by a dry blending or a melt kneading in a single or twin screw extruder.

The stretched film of the present invention is produced by melt-kneading the polyamide resin X with the amorous polyamide resin Y and/or the ionomer resin Z, extruding the resin mixture in the form of film, and then stretching the film in at least one direction of MD and TD in a stretch ratio exceeding 4 times. The thickness of the stretched film is preferably from 5 to 40 μm. If being 5 μm or more, the stretching can be effected without breaking and the deterioration of transparency can be prevented. If being 40 μm or less, the film is stretched uniformly and the uneven thickness can be avoided.

The stretched film of the present invention is produced by stretching a raw film which is obtained by a film-forming method such as a T-die method and a cylindrical die method (inflation method). The raw film is preferably produced by melt-extruding the resin mixture preferably at 250 to 290° C. and more preferably at 250 to 270° C. If the extrusion temperature is high, the decomposition, gelation, discoloration and foaming occur. The stretching may be conducted by a simultaneous biaxial stretching or a successive biaxial stretching. The stretching temperature is preferably from 90 to 160° C. and more preferably from 110 to 150° C. Within the above range, the defective stretching and whitening can be prevented.

When a film made of only nylon MXD6 is stretched in a ratio of 4 times or more in at least one direction of MD and TD, the film is broken and the transparency and gas-barrier properties are deteriorated. However, the stretching in a ratio exceeding 4 times can be successfully performed if the amorous polyamide resin Y and/or the ionomer resin Z is added to the polyamide resin X. The stretch ratio in the direction of MD and/or TD is preferably from 4.1 to 10 times, more preferably from 4.5 to 10 times, and still more preferably from 5.1 to 9 times.

The stretched film of the present invention made of the resin mixture of the polyamide resin X with the amorous polyamide resin Y and/or the ionomer resin Z may be made into a multi-layer film by combining a film made of another thermoplastic resin. For example, a multi-layer film improved in the impact resistance and flexibility is obtained by combining an aliphatic polyamide film.

The multi-layer film is produce, for example, by laminating the stretched film of the present invention with a thermoplastic resin film. The films may be laminated by an adhesive. The thermoplastic resin films may be laminated on both surfaces of the stretched film. Examples of the thermoplastic resin include low-density polyethylene, high-density polyethylene, linear low-density polyethylene, polypropylene, polybutene, olefin copolymers, ionomer resins, ethylene-acrylic acid copolymer, ethylene-vinyl acetate copolymer, and modified polyolefin resin. These thermoplastic resins may be used alone or in combination. The thermoplastic resin film may be single-layered or multi-layered, and may be stretched or non-stretched. Examples of the adhesive include a graft-modified product which is prepared by modifying a polymer such as ethylene-vinyl acetate copolymer, high-density polyethylene, low-density polyethylene, linear low-density polyethylene, and polypropylene with maleic anhydride. A composition mainly composed of such graft-modified product is also usable as the adhesive.

Alternatively, a stretched multi-layer film is produced by separately melt-extruding the resin mixture of the polyamide resin X with the amorous polyamide resin Y and/or the ionomer resin Z, an adhesive resin and the thermoplastic resin into a multi-layer film, and then stretching the multi-layer film in a ratio exceeding 4 times in the direction of MD and/or TD. Like the production of the stretched single-layer film mentioned above, the stretched multi-layer film is produced by stretching a raw film which is obtained by a film-forming method such as a co-extrusion T-die method and a co-extrusion cylindrical die method (inflation method). The stretching may be conducted by a simultaneous biaxial stretching or a successive biaxial stretching. The same stretching conditions (stretching temperature, stretch ratio, etc.) as in the production of the stretched single-layer film mentioned above are applicable to the production of the stretched multi-layer film.

Examples of the thermoplastic resin used in the production of the stretched multi-layer film include low-density polyethylene, high-density polyethylene, linear low-density polyethylene, polypropylene, polybutene, olefin copolymers, ionomer resins, ethylene-acrylic acid copolymer, ethylene-vinyl acetate copolymer, and modified polyolefin resin. These thermoplastic resins may be used alone or in combination.

Examples of the adhesive resin include a graft-modified product which is prepared by modifying a polymer such as ethylene-vinyl acetate copolymer, high-density polyethylene, low-density polyethylene, linear low-density polyethylene, and polypropylene with maleic anhydride. A composition mainly composed of such graft-modified product is also usable as the adhesive resin.

In the laminate film or stretched multi-layer film of the present invention, the layer made of the mixture of the polyamide resin X with the amorous polyamide resin Y and/or the ionomer resin Z acts as a gas-barrier layer.

The layered structure of the laminate film or stretched multi-layer film of the present invention generally includes a three-kind/three-layer structure such as A/B/C and a three-kind/five-layer structure such as C/B/A/B/C and further includes a layered structure of A/B/A/B/C, wherein A is the gas-barrier layer, B is the adhesive layer, and C is the thermoplastic resin layer. In a preferred embodiment, the thickness of the layer A is from 2 to 50 μm, the thickness of the layer B is from 2 to 20 μm, the thickness of the layer C is from 10 to 100 μm, and the total thickness of each of the laminate film and multi-layer stretched film is from 30 to 200 μm.

The stretched film, laminate film and multi-layer stretched film of the present invention exhibit a little decrease in the gas-barrier properties and a quick recovery of the gas-barrier properties even when being subjected to boiling treatment or retort treatment, and therefore, are suitable as packaging materials for foods such as processed meat foods, boiled foods and retorted foods and packaging materials for other products.

The opening of packaging material may be heat-sealed, tied by a ligature such as clip, and bound by other means. A tubular film is cut into a desired length and one of the open ends is heat-sealed or ligated for use, if necessary.

### EXAMPLES

The present invention will be described in more detail with reference to the following examples. However, it should be noted that the following examples are merely illustrative and the scope of the present invention is not limited thereto.

The properties of the stretched films were measured by the following methods.

### (1) Haze

Measured according to ASTM D1003 using a color deference/turbidity meter “Model COH-300A” manufactured by Nippon Denshoku Industries Co., Ltd.

### (2) Oxygen Permeability

Measure according to ASTM D3985 under the conditions of 23° C. and 60% relative humidity using an oxygen permeation instrument “OX-TRAN Model 10/50A” manufacture by Modern Controls, Inc.

### Example 1

A resin mixture was prepared by dry-blending 80 parts by weight of nylon MXD6 (“MX nylon 6007,” tradename, manufactured by Mitsubishi Gas Chemical Company, Inc.) and 20 parts by weight of an amorphous polyamide resin (“Selar PA 3426,” tradename, manufactured by Du Pont-Mitsui Polychemicals Co., Ltd.). The resin mixture was extruded from an extruder having a 20-mm diameter cylinder (Labo Plastomil manufactured by Toyo Seiki Seisaku-Sho, Ltd.) at 260 to 270° C., and made into a raw film by a T-die-cooling roll method. To compare films stretched by different ratios, several raw films having different thicknesses were produced so that these films had the same thickness after stretching. The raw films were stretched by a biaxial stretching machine (tenter method) manufactured by Toyo Seiki Seisaku-Sho, Ltd. at 130° C. in the machine direction in a ratio of 4 to 6 times to obtain stretched films. The transparency (haze) and oxygen permeability of the stretched films are shown in Table 1.

### Example 2

In the same manner as in Example 1 except for using 5 parts by weight of an ionomer resin (“Himilan AM6004,” tradename, manufactured by Du Pont-Mitsui Polychemicals Co., Ltd.) in place of the amorphous polyamide resin, stretched films were produced. The transparency (haze) and oxygen permeability of the stretched films are shown in Table 2.

### Example 3

A resin mixture for gas-barrier layer was prepared by dry-blending 20 parts by weight of nylon MXD6 (“MX nylon 6007,” tradename, manufactured by Mitsubishi Gas Chemical Company, Inc.) and 20 parts by weight of an amorphous polyamide resin (“Selar PA 3426,” tradename, manufactured by Du Pont-Mitsui Polychemicals Co., Ltd.). Polypropylene (layer C, “Novatec PP FL6CK,” tradename, manufactured by Japan Polypropylene Corporation) was extruded at 200 to 210° C. from an extruder having a 45-mm diameter cylinder, while extruding an adhesive resin (layer B, “Modic P513V,” tradename, manufacture by Mitsubishi Chemical Corporation) at 190 to 200° C. from an extruder having a 40-mm diameter cylinder and extruding the resin mixture for gas-barrier layer (layer A) at 260 to 270° C. from an extruder having a 30-mm diameter cylinder. The extruded resins were allowed to pass through a feed block and made into a molten multi-layer body (layer C/layer B/layer A). The molten multi-layer body was made into multi-layer films by a T-die-cooling roll method. To compare films stretched by different ratios, several raw multi-layer films having different thicknesses were produced so that these films had the same thickness after stretching. The multi-layer films were monoaxially stretched by a roll monoaxial stretching machine at 150° C. in the machine direction in a ratio of 4 to 8 times to obtain stretched multi-layer films. The thickness of each layer, transparency (haze) and oxygen permeability of the stretched multi-layer films are shown in Table 3.

### Comparative Example 1

Stretched films were produced in the same manner as in Example 1 except for using only nylon MXD6 (“MX nylon 6007,” tradename, manufactured by Mitsubishi Gas Chemical Company, Inc.). The transparency (haze) and oxygen permeability of the stretched films are shown in Tables 1 and 2.

### Comparative Example 2

Stretched multi-layer films were produced in the same manner as in Example 1 except for using only nylon MXD6 (“MX nylon 6007,” tradename, manufactured by Mitsubishi Gas Chemical Company, Inc.) as the resin for gas-barrier layer. The thickness of each layer, transparency (haze) and oxygen permeability of the stretched multi-layer films are shown in Table 3.

TABLE 1
(stretched single-layer film)

| | | | | Comparative | |
|---|---|---|---|---|---|
| | Example 1 | | | Example 1 | |
| Resin mixture (weight ratio) | | | | | |
| MX nylon 6007 | 80 | 80 | 80 | 100 | 100 |
| Selar PA3426 | 20 | 20 | 20 | 0 | 0 |
| Stretching temperature (° C.) | 130 | 130 | 130 | 130 | 130 |
| MD stretch ratio (times) | 4.5 | 5 | 6 | 4.5 | 5 |
| Thickness of raw film (μm) | 69 | 84 | 85 | 70 | 95 |
| Break during stretching | none | none | none | none | occurred |
| Thickness of stretched film (μm) | 15 | 16 | 14 | 15 | — |
| Evaluation Results | | | | | |
| haze (%) | 2.5 | 3.0 | 3.5 | 15.0 | — |
| oxygen permeability | 4.5 | 4.0 | 4.7 | 12.0 | — |
| (cc/m² · day · atm) | | | | | |

TABLE 2
(stretched single-layer film)

| | | | | Comparative | |
|---|---|---|---|---|---|
| | Example 2 | | | Example 1 | |
| Resin mixture (weight ratio) | | | | | |
| MX nylon 6007 | 95 | 95 | 95 | 100 | 100 |
| Selar PA3426 | 5 | 5 | 5 | 0 | 0 |
| Stretching temperature (° C.) | 130 | 130 | 130 | 130 | 130 |
| MD stretch ratio (times) | 4.5 | 5 | 6 | 4.5 | 5 |
| Thickness of raw film (μm) | 68 | 84 | 85 | 70 | 95 |
| Break during stretching | none | none | none | none | occurred |
| Thickness of stretched film (μm) | 15 | 16 | 14 | 15 | — |
| Evaluation Results | | | | | |
| haze (%) | 3.5 | 3.7 | 4.5 | 15.0 | — |
| oxygen permeability | 4.1 | 3.8 | 4.4 | 12.0 | — |
| (cc/m² · day · atm) | | | | | |

TABLE 3
(stretched multi-layer film)

| | | | | Comparative | |
|---|---|---|---|---|---|
| | Example 3 | | | Example 2 | |
| Resin of gas-barrier layer | | | | | |
| (weight ratio) | | | | | |
| MX nylon 6007 | 80 | 80 | 80 | 100 | 100 |
| Selar PA3426 | 20 | 20 | 20 | 0 | 0 |
| Stretching temperature (° C.) | 150 | 150 | 150 | 150 | 150 |
| MD stretch ratio (times) | 5 | 6 | 5 | 5 | 6 |
| Thickness of raw film (μm) | 345 | 415 | 550 | 370 | 420 |
| Break during stretching | none | none | none | none | occurred |
| Thickness of stretched film (μm) | | | | | |
| layer A (gas-barrier layer) | 14 | 13 | 16 | 13 | — |
| layer B (Tie*) | 5 | 5 | 4 | 5 | — |
| layer C (PP*) | 50 | 52 | 51 | 55 | — |
| total thickness | 69 | 70 | 71 | 73 | — |
| Evaluation Results | | | | | |
| haze (%) | 6.5 | 7.0 | 6.8 | 16.0 | — |
| oxygen permeability | 5.0 | 5.3 | 4.4 | 13.5 | — |
| (cc/m² · day · atm) | | | | | |

Tie*: adhesive resin (Modic P513V)
PP*: polypropylene (Novatec PP FL6CK)

### INDUSTRIAL APPLICABILITY

In the present invention, an amorphous polyamide resin and/or a ionomer resin is added to a polyamide having m-xylylene skeleton. With such addition, films can be stretched in a high ratio without breaking to increase the productivity. The resultant stretched films are excellent in the transparency and gas-barrier properties, and the gas-barrier properties are little reduced and immediately recovered even when subjected to boiling treatment or retort treatment. Therefore, the stretched films are suitable as packaging materials for food, medicines, industrial chemicals, cosmetics, inks, and other products.

1. A stretched film which is produced by melt-mixing a polyamide resin X with an amorphous polyamide resin Y and/or an ionomer resin Z in a weight ratio, X/(Y+Z), of 70/30 to 95/5, the polyamide resin X comprising a diamine-constitutional unit containing 70 mol % or more of m-xylylene diamine unit and a dicarboxylic acid constitutional unit containing 70 mol % or more of C₆-C₁₂ α, ω-aliphatic dicarboxylic acid unit; extruding the mixture into a form of film; and stretching the film in a stretch ratio exceeding 4 times in at least one direction of MD and TD.

2. The stretched film according to claim 1, wherein the mixture comprises the polyamide resin X and the amorphous polyamide resin Y.

3. The stretched film according to claim 1, wherein the mixture comprises the polyamide resin X and the ionomer resin Z.

4. The stretched film according to claim 1, wherein the amorphous polyamide resin Y is at least one hexamethylenediamine-isophthalic acid-terephthalic acid copolyamide selected from the group consisting of nylon 6I, nylon 6T, nylon 6IT, and nylon 6I6T wherein I represents isophthalic acid, and T represents terephthalic acid.

5. The stretched film according to claim 1, wherein the ionomer resin Z is at least one ionomer resin selected from the group consisting of ethylene-acrylic acid copolymer, ethylene-methacrylic acid copolymer and ethylene-methacrylic acid-acrylic acid copolymer, the pendant carboxyl groups of each copolymer being partially neutralized by metal ions.

6. The stretched film according to claim 5, wherein a degree of neutralization of the carboxyl groups in the ionomer resin Z is from 20 to 40% when expressed by a ratio of number of neutralized carboxyl groups/total number of carboxyl groups.

7. A laminate film comprising the stretched film as defined in claim 1 and a thermoplastic resin film.

8. The laminate film according to claim 7, wherein the thermoplastic resin is at least one resin selected from the group consisting of low-density polyethylene, high-density polyethylene, linear low-density polyethylene, polypropylene, polybutene, olefin copolymers, ionomer resins, ethylene-acrylic acid copolymer, ethylene-vinyl acetate copolymer, and modified polyolefin resin.

9. A stretched multi-layer film produced by respectively melt extruding a resin mixture, an adhesive resin and a thermoplastic resin to produce a multi-layer film and stretching the multi-layer film in a stretch ratio exceeding 4 times in at least one direction of MD and TD, wherein the resin mixture comprises a polyamide resin X and an amorphous polyamide resin Y and/or an ionomer resin Z in a weight ratio, X/(Y+Z), of 70/30 to 95/5, and wherein the polyamide resin X comprises a diamine constitutional unit containing 70 mol % or more of m-xylylene diamine unit and a dicarboxylic acid constitutional unit containing 70 mol % or more of C₆-C₁₂ α, ω-aliphatic dicarboxylic acid unit.

10. The stretched multi-layer film according to claim 9, wherein the resin mixture comprises the polyamide resin X and the amorphous polyamide resin Y.

11. The stretched multi-layer film according to claim 9, wherein the resin mixture comprises the polyamide resin X and the ionomer resin Z.

12. The stretched film according to claim 2, wherein the amorphous polyamide resin Y is at least one hexamethylenediamine-isophthalic acid-terephthalic acid copolyamide selected from the group consisting of nylon 6I, nylon 6T, nylon 6IT, and nylon 6I6 T wherein I represents isophthalic acid, and T represents terephthalic acid.

13. The stretched film according to claim 3, wherein the ionomer resin Z is at least one ionomer resin selected from the group consisting of ethylene-acrylic acid copolymer, ethylene-methacrylic acid copolymer and ethylene-methacrylic acid-acrylic acid copolymer, the pendant carboxyl groups of each copolymer being partially neutralized by metal ions.

14. The stretched film according to claim 13, wherein a degree of neutralization of the carboxyl groups in the ionomer resin Z is from 20 to 40% when expressed by a ratio of number of neutralized carboxyl groups/total number of carboxyl groups.
